(19) United States
(12) Patent Application Publication
(10) Pub. No.: US 2002/0135332 A1
(43) Pub. Date: Sep. 26, 2002

(54) Method and apparatus for preventing motor over temperature for a window closure system

(75) Inventor: Allan Losey, Ortonville, MI (US)

Correspondence Address: LAURA M. SLENZAK, SIEMENS CORPORATION, 186 WOOD AVENUE SOUTH, ISELIN, NJ, 08830, US

(73) Assignee: Siemens VDO Automotive Corporation

(21) Appl. No.: 10/100,356

(22) Filed: Mar. 18, 2002

Related U.S. Application Data
(60) Provisional application No. 60/277,133, filed on Mar. 20, 2001.

(51) Int. Cl. H02P 1/00; H02P 3/00; G05B 5/00; H02P 7/00; H02H 7/08

(52) U.S. Cl. 318/445

(57) ABSTRACT

A control system and method predicts the occurrence of elevated temperatures in an electric motor 12 used to operate a window closure system. The motor 12 includes an output 14 that is operably coupled to a window component 16. A controller 20 monitors at least one motor characteristic, such as motor activation occurrence or duration of activation, over a period of time and generates an output signal 22. The controller 20 prohibits operation of the motor 12 when the output signal 22 exceeds a predetermined limit.

### CROSS-REFERENCE TO RELATED APPLICATIONS

The application claims priority to U.S. Provisional Application No. 60/277,133, which was filed on Mar. 20, 2001.

### BACKGROUND OF THE INVENTION

This invention relates to a method and system that prevents over-heating in electric motors that are used to operate a window closure mechanism.

Electric motors are used operate window closure mechanisms by moving a window panel between various operational positions. These types of motors are usually small in size and operate for discrete periods of time, i.e. the motors are not continuously running. Because these motors are designed for intermittent operation, the motors can overheat if multiple operations occur over a short period of time. Prolonged exposure to elevated temperatures can cause accelerated motor component wear, which can lead to premature component damage or failure.

Traditionally, these motors include a thermal breaker switch, which is sensitive to temperature changes within the motor. If the motor exceeds a predetermined temperature then the thermal breaker switch automatically activates to open the circuit to the motor, thus preventing further operation of the motor. One disadvantage with this type of system is that the motor is still subjected to elevated temperatures for at least a short period of time, which can damage the components.

One solution to motor over-heating has been incorporated into motors used to operate door latches. Motor characteristics are monitored in an attempt to predict when over-heating will occur in the door latch motor. However, this solution has never been utilized in window closure applications.

Thus, it is desirable to have a method and system that can predict over-heating of an electric motor for a window closure mechanism before the motor is exposed to elevated operating temperatures, as well as overcoming the other above mentioned deficiencies with the prior art.

### SUMMARY OF THE INVENTION

A control system and method predicts the occurrence of elevated temperatures in an electric motor used to operate a window closure system. A motor output member is operably coupled to drive a window component. A controller monitors at least one electric motor characteristic for a period of time and generates an output signal based on the monitored characteristic. The output signal is compared to a predetermined limit and operation of the motor output member is prohibited when the output signal exceeds the predetermined limit.

Preferably, motor operation is prohibited for a predetermined length of time so that the motor will have sufficient time to cool down. The controller preferably monitors the number of motor activations that occur over a period of time and prohibits motor operation when the number of motor activations exceeds a predetermined number of activations per a predetermined period of time. The controller can also monitor duration of each activation and duration of time between activations.

The subject system and method predict possible over-heating conditions in an electric motor for a window closure and prevents further motor operation until the motor has cooled sufficiently. These and other features of the present invention can be best understood from the following specifications and drawings, the following of which is a brief description.

### BRIEF DESCRIPTION OF THE DRAWINGS

FIG. 1 is a schematic diagram of an electric motor for operating a window closure system, which incorporates the subject invention.

FIG. 2 is a flowchart describing a method incorporating the subject invention.

### DETAILED DESCRIPTION OF A PREFERRED EMBODIMENT

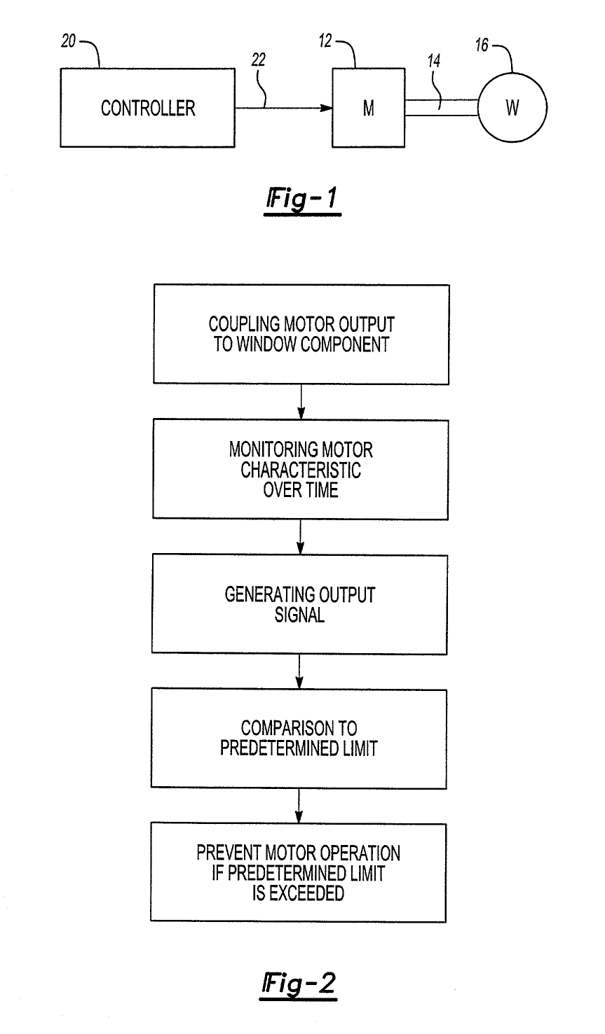

An electric motor control system for a window closure application is shown generally at 10 in FIG. 1. The control system 10 includes an electric motor 12 having an output member 14 that is coupled to drive a window component 16. The motor 12 drives the output member 14, as is known in the art, to move the window 16 been various operational positions.

The motor 12 is operably connected to a controller 20 that monitors at least one motor characteristic. The controller 20 monitors and/or measures the motor characteristic over a period of time and generates an output signal 22 based on the information collected during monitoring and measurement. The output signal 22 is compared to a predetermined limit and if the predetermined limit is exceeded the controller 20 prohibits further operation of the motor for a predetermined length of time. The predetermined length of time can vary depending upon application, however, the length of time should be sufficient to allow the motor 12 to cool to an acceptable operational temperature.

The controller 20 can monitor any of various motor characteristics either alone or in combination with each other over a predetermined period of time prior to generating the output signal 22. Preferably, the controller 20 counts the number of motor activations that occur during a period of time. The predetermined limit can then be set to a predetermined number of activations per predetermined period of time ratio. This ratio can vary depending on the type of window closure being moved. If the ratio is exceeded then further operation of the motor is prevented.

The controller 20 can also measure the duration of each activation cycle. For example, the controller can measure that a first activation cycle lasts five seconds, a second activation cycle lasts 2 seconds, a third activation cycle lasts ten seconds, etc. The controller 20 then takes into account the number and duration of motor activations and compares this to a predetermined limit to predict potential over-heating within the motor.

The controller 20 can also measure the duration of rest time between cycles, i.e., the period of time that the motor 12 is not activated. The controller then takes into account the number and duration of motor activations and the rest periods and compares this to a predetermined limit to predict potential overheating.

The subject control system 10 provides a simplified method and apparatus for predicting occurrence of over-heating conditions in an electric motor for a window closure system. One of the benefits with the subject invention is that further operation of the motor can be prohibited before the elevated temperatures are actually experienced by the motor components, resulting in reduced wear and tear on the components. Although a preferred embodiment of this invention has been disclosed, a worker of ordinary skill in this art would recognize that certain modifications would come within the scope of this invention. For that reason, the following claims should be studied to determine the true scope and content of this invention.

1. An electric motor control system for operating a window closure system comprising:
an electric motor drive member;
a window member operably coupled to said drive member and movable between a plurality of operational positions; and
a controller for selectively activating said window member to drive said window member to a desired one of said operational positions wherein said controller monitors at least one motor operational characteristic over a period of time to generate a motor characteristic signal, compares said motor characteristic signal to a predetermined limit, and temporarily prohibits movement of said window member when said motor characteristic signal exceeds said predetermined limit.

2. An electric motor control system as set forth in claim 1 wherein said controller prohibits movement of said window member for a predetermined length of time when said motor characteristic signal exceeds said predetermined limit.

3. An electric motor control system as set forth in claim 1 wherein said controller monitors said at least one motor operational characteristic by timing occurrences of said at least one motor operational characteristic.

4. An electric motor control system as set forth in claim 1 wherein said at least one motor operational characteristic is activations of said drive member and said controller counts the number of activations and sets said predetermined limit based on number of activations per a predetermined period of time.

5. An electric motor control system as set forth in claim1 wherein said at least one motor operational characteristic is duration of each activation and said controller counts the number of activations, times the duration of each activation and sets said predetermined limit based on number and duration of said activations per a predetermined period of time.

6. A method for predicting occurrence of elevated temperatures in an electric motor for a window closure system comprising the steps of:
(a) operably coupling an electric motor output member to a window component that is movable between a plurality of operational positions;
(b) monitoring at least one electric motor characteristic over a period of time;
(c) generating an output signal based on data generated during step (b);
(d) comparing the output signal to a predetermined limit; and
(e) prohibiting further operation of the electric motor output member when the output signal exceeds the predetermined limit.

7. The method of claim 6 wherein step (e) further includes prohibiting further operation of the electric motor output member for a predetermined length of time.

8. The method of claim 6 wherein step (b) further includes counting the number of activations of the electric motor output member and step (d) further includes comparing the number of activations per period of time to the predetermined limit.

9. The method of claim 8 wherein the predetermined limit is defined by a predetermined number of motor output member activations occurring within a predetermined amount of time.

10. The method of claim 8 wherein step (b) further includes timing the duration of each activation of the electric motor output member.

11. The method of claim 10 wherein the predetermined limit is defined by a predetermined number of motor output member activations occurring within a predetermined amount of time with at least one of the activations achieving a predetermined duration of time.

12. The method of claim 10 wherein step (b) further includes timing the duration of time between each activation of the electric motor output member.
